(19) United States
(12) Patent Application Publication
(10) Pub. No.: US 2007/0265121 A1
(43) Pub. Date: Nov. 15, 2007

(54) DRIVE CHAIN MOTION STABILIZER

(76) Inventor: Jimmy Gross, Tacoma, WA (US)

Correspondence Address: AXIOS LAW GROUP. PLLC, 1525 FOURTH AVENUE, SUITE 800, SEATTLE, WA, 98101, US

(21) Appl. No.: 11/746,571

(22) Filed: May 9, 2007

Related U.S. Application Data
(60) Provisional application No. 60/746,829, filed on May 9, 2006.

(51) Int. Cl. B62J 13/00

(52) U.S. Cl. 474/144

(57) ABSTRACT

A system for the control and stabilization of movements of a drive chain for bicycles is provided herein.

### RELATED INVENTIONS

This application claims the benefit of U.S. Provisional Application No. 60/746,829, entitled DRIVE CHAIN MOTION STABILIZER, filed on May 9, 2006, which is incorporated herein in its entirety.

### FIELD

The subject matter disclosed herein relates to chain stabilizers and more particularly to a bicycle drive chain motion stabilizer (“DCMS”) used to control undesired chain movement.

### BACKGROUND

Bicycles have long been a popular means of transportation and recreation. Since their invention, bicycles have been used for an increasing number of activities from commuting to competition. Over time, bicycles have become more and more customized for particular uses. Similarly, bicycle components and accessories have become more and more specialized to fulfill the particular needs of each activity.

Recently, mountain biking has become a popular recreational activity as well as a highly competitive sport. Due to the nature of their use, mountain bikes are often designed for a variety of terrain from smooth surfaces to extremely rough terrain. Because mountain biking is a year round sport, mountain bikes must also be built to withstand extreme weather and temperature conditions.

Like most bicycles, mountain bikes use a multi-stage gear assembly consisting of front and rear sprockets, a front and rear derailleur and a drive chain. The number of derailleurs and sprockets will vary depending upon the bike's use and design. Most often, mountain bikes have multiple front and rear sprockets and both a front and rear derailleur. Since the length of drive chain needed to operate between the numerous sprockets will vary depending upon the chosen gear, a chain tensioning device is often used to take up the excess chain length or slack and keep the drive chain from slipping out of the chosen gear. Most often, the chain tensioning device is incorporated into the rear derailleur.

When riding over rough terrain, jumping, or riding downhill, the rider will often coast or stop peddling the bike in order to maintain stability and control. During this time, the drive chain is not in motion and is stabilized by the tensioning device of the bike. The weight of the drive chain, in combination with the abrupt and radical movements of the bike during use, is often enough to overcome the tension supplied by the typical tensioning device or rear derailleur. The drive chain will then move, or “flop” around in an uncontrolled manner known as “chain whip.”

Chain whip can cause the drive chain to come in contact with the bike frame where it not only can damage the frame but can also damage the drive chain itself. Chain whip can also cause the drive chain to jump out of gear or come off the front or rear sprockets. Excess lower chain whip can also cause the rear derailleur to break or jam during use or damage the derailleur through continued uncontrolled movements of the drive chain.

Not only can uncontrolled chain movement cause damage to the bike, but it can create a safety hazard as well. Excessive chain whip can cause the drive chain to catch on the rear tire and be taken into the space between the frame and the wheel during wheel rotation. Such an action can cause the drive chain as well as rear wheel to jam or stop functioning, presenting a safety hazard when riding downhill or at high rates of speed. Not only can the jam cause damage to the bike, the rider can lose control and be thrown from the bike.

### BRIEF DESCRIPTION OF THE DRAWINGS

FIG. 1 is a view of an embodiment of the drive chain motion stabilizer as it is mounted on a bike.

FIG. 2 is a perspective view of the embodiment of the drive chain motion stabilizer.

FIG. 3 is a perspective view of an alternate embodiment of the drive chain motion stabilizer.

FIG. 4 is a perspective view of an alternate embodiment of the drive chain motion stabilizer.

FIG. 5 is a perspective view of an alternate embodiment of the drive chain motion stabilizer.

### DETAILED DESCRIPTION

The following description is of exemplary embodiment of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention as set forth in the appended claims.

In one exemplary embodiment, the drive chain motion stabilizer (“DCMS”) has a frame, two piston dampeners and an upper and lower chain guide. The example DCMS may connect to the rear frame structure of a bike between the front and rear gears near the midpoint of the drive chain. The DCMS may provide guidance, protection and/or control of the drive chain. The upper portion of the DCMS has a chain guide that extends from the lowest vertical drive chain travel path to the tallest vertical drive chain path. Similarly, the lower chain guide may extend to the highest and lowest travel path of the drive chain on its lower path. The chain guide housing can contain a chain guide insert with a properly spaced and angled channel having both vertical and horizontal spacing to accommodate the varying positions of the drive chain during all gear selections. As the drive chain moves during use and gear selection, it comes into contact with the upper and lower chain guides and causes them to move relative to the drive chain position in the vertical direction. The dampening pistons of the DCMS can control the motion of the upper and lower chain guides thereby dampening the vertical movement of the drive chain. The pistons may be filled with water, oil, air, dampening fluid or the like, whereby the resistance can be changed through the use of different weights of fluid or air pressure. Alternatively, the pistons can be comprised of at least one spring or be replaced with a dampening structure comprised of at least one spring. The spring would then act to dampen the movement of the chain guide housing. Multiple springs can also be incorporated to dampen the movement of the housing in all vertical directions. Multiple DCMSs can also be used in conjunction on bikes where the drive chain is lengthy or where the drive chain has excessive slack.

The example DCMS can ensure that the drive chain maintains a straight traveled path during all chain and suspension movements. During the operation of the bike, the chain guide maintains the drive chain position and allows it to move freely within the chain guide without binding and without supplying unnecessary tension to the drive chain. The DCMS can reduce chain whip and chain slap and may provide frame protection. Further, the DCMS may reduce overall noise created from the uncontrolled chain motion. The exemplary DCMS may also stop the drive chain from hitting the rear tire and being taken in between frame and tire where it can cause the rear wheel to lock.

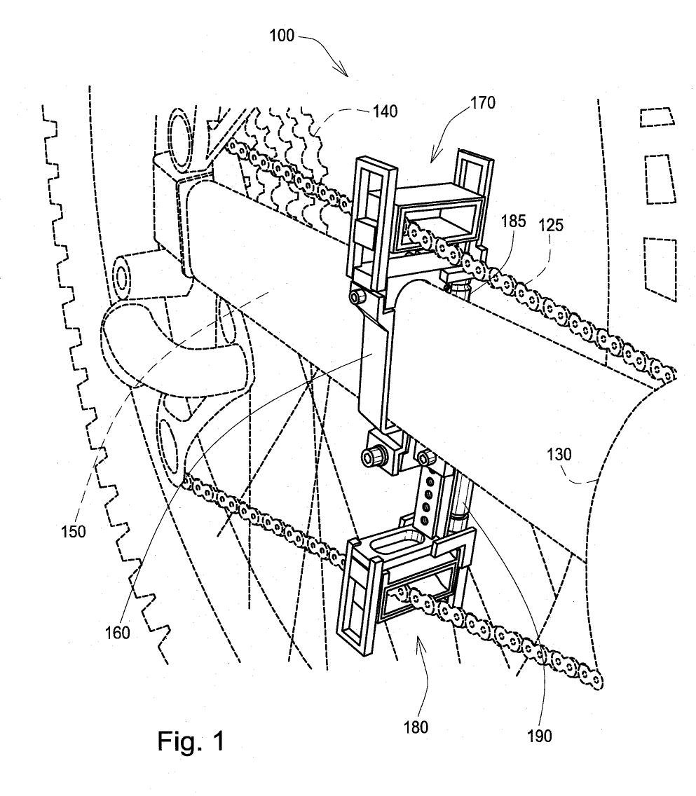

FIG. 1 shows a DCMS 100 mounted to the rear portion of a bicycle frame 150, or rear swing arm, at the approximate midpoint of the drive chain 125 between the front sprocket 130 and rear sprocket 140 according to an embodiment of the DCMS disclosed herein. The DCMS 100 has a mounting bracket 160 that can be used to connect it to the bicycle frame 150. The DCMS 100 includes an upper chain guide 170 and a lower chain guide 180. The upper chain guide 170 and a lower chain guide 180 contain and control the vertical and horizontal movement of the drive chain 125 during use. The DCMS 100 may ensure that the drive chain 125 maintains a straight travel path during all drive chain 125 and suspension movements through all gear selections without additional restriction, tension or stress being applied to the drive chain 125. While the horizontal movement of the drive chain 125 can be restricted by the upper chain guide 170 and a lower chain guide 180, the upper chain guide 170 and a lower chain guide 180 may move with the drive chain in the vertical direction and can dampen its movement through the use of upper damping piston 185 and lower damping piston 190. The DCMS 100 may reduce unwanted drive chain 125 motion, and can provide control, containment, protection, and safety.

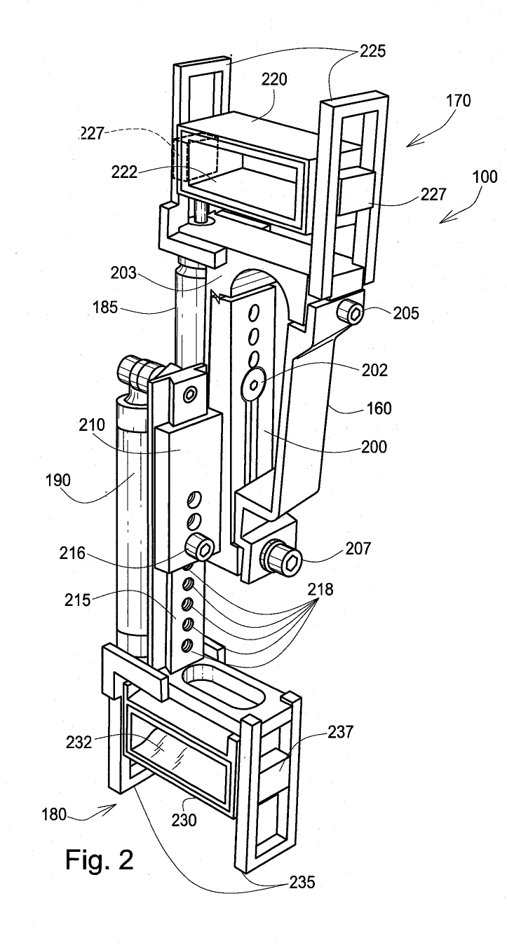

FIG. 2 shows another example of the DCMS 100 according to an embodiment of a DCMS disclosed herein. The DCMS 100 can include a frame 200, upper chain guide platform 203, lower guide flange 210, mounting bracket 160, upper chain guide 170, lower chain guide 180, upper damping piston 185 and lower damping piston 190. The mounting bracket 160 is attached to the upper chain guide platform 203 and frame 200 by upper bracket bolt 205 and lower bracket bolt 207 respectively. The upper chain guide platform 203 is adjustably attached to frame 200 by frame bolt 202. Lower guide flange 210 is affixed to frame 200 and is adjustably affixed to lower guide mount 215 using lower mount screw 216 and a plurality of position locators 218. Upper chain guide 170 may include an upper chain guide housing 220, upper chain guide housing insert 222, upper chain guide channels 225 and upper chain guide channel locaters 227. Upper chain guide housing insert 222 can be concentrically mounted within upper chain guide housing 220 and can be made of a semi-hard slick material such as urethane, polyurethane, silicone, plastic, rubber, wood or the like that will allow the drive chain 125 to pass over its surface with little resistance. Upper chain guide channel locaters 227 are attached to the upper chain guide housing 220 and can be located within the upper chain guide channels 225. During use, upper chain guide housing 220 can move in a vertical direction with the movements of drive chain 125 causing the upper chain guide locaters 227 to move within the upper chain guide channels 225. Upper damping piston 185 can be mounted to frame 200 and upper chain guide housing 220 and can dampen the movement of the upper chain guide housing 220 during movement.

Similarly, lower chain guide 180 can include a lower chain guide housing 230, lower chain guide housing insert 232, lower chain guide channels 235 and lower chain guide channel locater 237. Lower chain guide housing insert 232 can be concentrically mounted within lower chain guide housing 230 and can be made of a semi-hard slick material such as urethane, polyurethane, silicone, plastic, rubber, wood or the like that will allow the drive chain 125 to pass over its surface with little resistance. Lower chain guide channel locater 237 can be attached to the lower chain guide housing 230 and can be located within the lower chain guide channel 235. During use, lower chain guide housing 230 can move in a vertical direction with the movements of drive chain 125 causing the lower chain guide locater 237 to move within the lower chain guide channel 235. Lower damping piston 190 can be mounted to frame 200 and lower chain guide housing 230 and can dampen the movement of the lower chain guide housing 230 during use. The vertical damping effect of DCMS 100 may reduce chain whip while allowing the drive chain 125 to move freely during use.

In most applications, the function of the rear derailleur may cause the drive chain 125 to have more pronounced movements in both the horizontal and vertical directions. As such, the lower chain guide 180 will often have a greater range of movement than the upper chain guide 170. The upper chain guide 170 and lower chain guide 180 can therefore operate independently from each other as the drive chain 125 travels in a different plane and pitch angle as it moves through the upper chain guide 170 than the lower chain guide 180.

Because the size of the front sprocket 130 and rear sprocket 140 can vary, the distance between the upper and lower path of the drive chain 125 can also vary greatly. Variations in bike size and design can also influence this distance. To accommodate such variations, the overall length of the DCMS 100 can be adjusted. The upper chain guide platform 203 can be moved in the vertical along the frame 200 by use of the frame bolt 202. Similarly, the lower guide mount 215 can be moved in the vertical direction along lower guide flange 210 using lower mount screw 216 and a plurality of position locators 218. The distance between upper chain guide 170 and lower chain guide 180 can then be increased or decreased.

The upper chain guide housing insert 222 and lower chain guide housing insert 232 can also be made of a nylon oil-filled plastic or from a semi-hard sponge-like material that can hold chain lubricant which will be applied to drive chain 125 during use. The upper chain guide housing insert 222 and lower chain guide housing insert 232 can also be made with a slight crown on all the surfaces so there is less surface contact between the upper chain guide housing insert 222 and lower chain guide housing insert 232 and the drive chain 125.

The upper chain guide housing insert 222 and lower chain guide housing insert 232 can furthermore be made with bristles or brushes such that drive chain 125 can be cleaned during use. Both the upper chain guide housing insert 222 and lower chain guide housing insert 232 can be incorporated into the upper chain guide housing 220 and lower chain guide housing 230 respectively and made as a single unit.

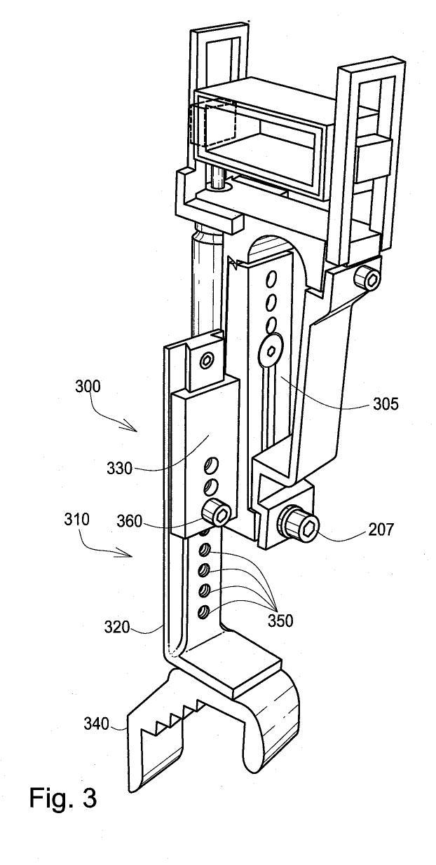

FIG. 3 shows an alternative embodiment of a DCMS 300 according to an embodiment of a DCMS disclosed herein. The lower chain guide 180 can be replaced with a lower drive chain stop 310 comprising a lower stop mount 320 and a lower stop 340. Lower stop mount 320 can include a plurality of position locators 350 to accommodate lower stop screw 360. The lower stop screw 360 mounts to lower stop flange 330 and can be used to adjust the length of lower drive chain stop 310. The lower stop 340 can be mounted to the bottom distal end of lower stop mount 320. Lower stop 340 can be made wide enough and long enough to resist the unwanted vertical movement of the drive chain 125 and can keep it from hitting the bicycle frame 150 in all gears and drive chain 125 positions. Lower stop 340 can be made from a semi-hard slick material such as urethane, polyurethane, silicone, plastic, rubber, wood or the like that will allow the drive chain 125 to pass over its surface with little resistance. Lower stop 340 can also be made of a nylon oil-filled plastic or from a semi-hard sponge-like material that can hold chain lubricant which will be applied to drive chain 125 during use. The lower drive chain stop 310 can also be made from a single piece whereby the lower stop mount 320 and lower stop 340 are incorporated into a single unit that is mounted to frame 305. The lower drive chain stop 310 can also be incorporated into the frame 305 as a single unit.

Since the lower drive chain stop 310 can be vulnerable to damage from ground objects encountered while riding over rough terrain, the lower drive chain stop 310 can be made from a firm flexible material such as rubber, nylon, plastic or the like. The lower drive chain stop 310 can then bend or deflect when stuck by ground debris or when the bike is high centered, yet it can still extend downward far enough to resist the unwanted vertical movement of the drive chain 125 and to keep it from hitting the bicycle frame 150.

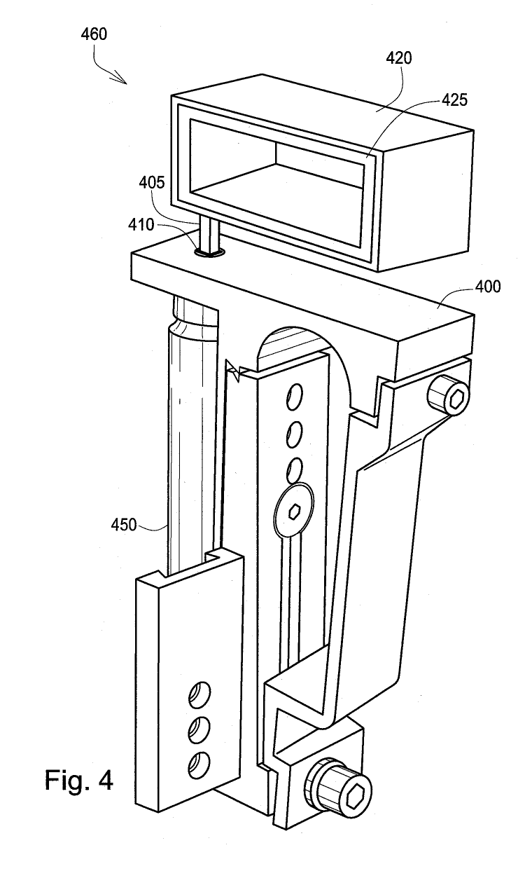

FIG. 4 shows an alternative embodiment of an upper chain guide 460 that can be similarly incorporated into the configuration of the lower chain guide 180. Upper damping piston 450 can incorporate a square piston shaft 405 thereby eliminating the need for the upper chain guide channels 225 and upper chain guide channel locaters 227. Upper chain guide platform 400 can include a square shaft guide 410 that can accommodate square piston shaft 405 and help prevent it from rotating out of position. The square piston shaft 405 and square shaft guide 410 maintain the position of upper chain guide housing 420 and upper chain guide housing insert 425 to keep them in alignment with the drive chain 125 in the vertical and horizontal positions without the need of the upper chain guide channel 225 and upper chain guide channel locater 227.

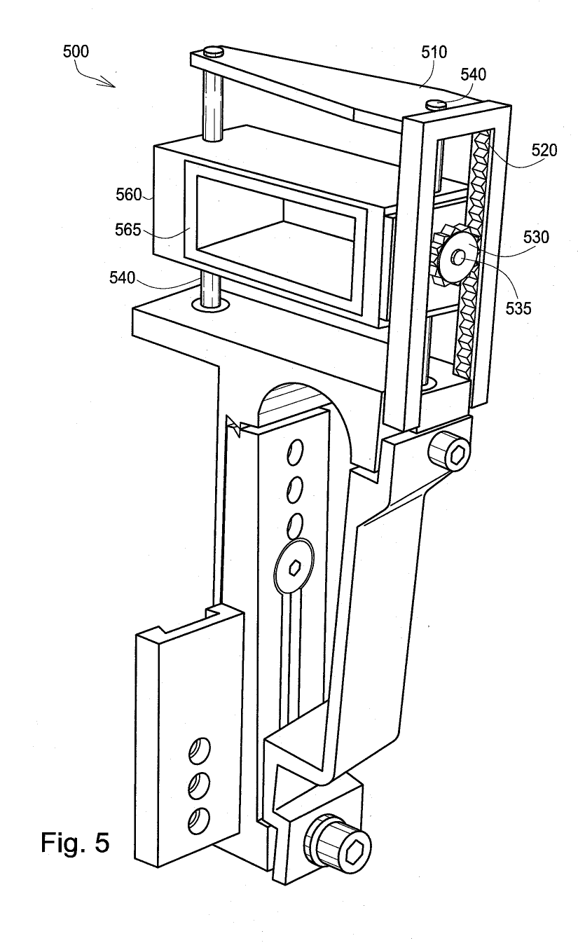

FIG. 5 shows yet another embodiment of the upper chain guide 500 that can be similarly incorporated into the position of the lower chain guide 180. Upper chain guide 500 can include an upper chain guide housing 560, upper chain guide housing insert 565, upper chain guide support frame 510, upper chain guide dampening gear 530 and upper chain guide travel bars 540. The upper chain guide housing 560 can be held in position and travels in the vertical direction upon the upper chain guide travel bars 540. Upper chain guide dampening gear 530 can be attached to the side of upper chain guide housing 560 by tension control pin 535. The upper chain guide dampening gear 530 contacts the gear track 520 of upper chain guide support frame 510 and travels in the vertical direction along with the vertical movements of upper chain guide housing 560. The tension of the upper chain guide dampening gear 530 can be adjusted with the tension control pin 535 to vary the amount of vertical dampening of the upper chain guide housing 560 by controlling the resistance of the upper chain guide dampening gear 530 as it moves along gear track 520 of upper chain guide support frame 510.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. This application is intended to cover any adaptations or variations of the embodiments discussed herein.

What is claimed is:

1. A chain motion stabilizer for a bicycle, comprising:
a mounting member configured for attachment to a bicycle frame;
a moveable upper chain guide connected to said mounting member and configured to receive a bicycle chain therethrough; and
a dampening structure connected to said moveable upper chain guide and said mounting member.

2. The chain motion stabilizer of claim 1 wherein said moveable upper chain guide further comprises of a removable insert having an internal cavity configured to receive the bicycle chain therethrough.

3. The chain motion stabilizer of claim 2 wherein said removable insert of said upper chain guide comprises an absorbent material.

4. The chain motion stabilizer of claim 2 wherein said removable insert of said upper chain guide comprises bristles.

5. The chain motion stabilizer of claim 1 wherein said dampening structure comprises a dampening piston.

6. The chain motion stabilizer of claim 1 wherein said dampening structure comprises a friction gear.

7. The chain motion stabilizer of claim 1 wherein said dampening structure comprises at least one spring.

8. The chain motion stabilizer of claim 1, further comprising at least one upper guide channel configured to receive said upper chain guide.

9. The chain motion stabilizer of claim 1, further comprising a lower chain stop connected to said mounting member.

10. The chain motion stabilizer of claim 9 wherein said lower chain stop comprises a flexible material.

11. The chain motion stabilizer of claim 1, further comprising:
a moveable lower chain guide connected to said mounting member and configured to receive the bicycle chain therethrough; and
a second dampening structure connected to said moveable lower chain guide and said mounting member.

12. The chain motion stabilizer of claim 11 wherein said second dampening structure comprises a dampening piston.

13. The chain motion stabilizer of claim 11 wherein said second dampening structure comprises a friction gear.

14. The chain motion stabilizer of claim 11 wherein said second dampening structure comprises at least one spring.

15. The chain motion stabilizer of claim 11, further comprising at least one lower guide channel configured to receive said lower chain guide.

16. The chain motion stabilizer of claim 11 wherein said moveable lower chain guide is further comprised of a removable insert having an internal cavity configured to receive the bicycle chain therethrough.

17. The chain motion stabilizer of claim 16 wherein said removable insert of said lower chain guide comprises an absorbent material.

18. The chain motion stabilizer of claim 16 wherein said removable insert of said lower chain guide comprises bristles.

19. A chain motion stabilizer for a bicycle comprising:
a mounting member configured for attachment to a bicycle frame;
a moveable upper chain guide connected to said mounting member and configured to receive a bicycle chain therethrough;
at least one upper chain guide channel configured to receive said upper chain guide;
a fluid filed piston damper connected to said moveable upper chain guide; and
a lower chain stop connected to said mounting member.

20. The chain motion stabilizer of claim 19 wherein said moveable upper chain guide is further comprised of a removable insert having an internal cavity configured to receive the bicycle chain therethrough.
